(19) United States
(12) Patent Application Publication
(10) Pub. No.: US 2016/0065848 A1
(43) Pub. Date: Mar. 3, 2016

(54) THERMOGRAPHY FOR A THERMAL IMAGING CAMERA

(71) Applicant: Seek Thermal, Inc., Santa Barbara, CA (US)

(72) Inventors: Tim LeBeau, Santa Barbara, CA (US); Blake Henry, San Barbara, CA (US); Ross Williams, Santa Barbara, CA (US)

(21) Appl. No.: 14/838,000

(22) Filed: Aug. 27, 2015

Related U.S. Application Data
(60) Provisional application No. 62/043,005, filed on Aug. 28, 2014.

(51) Int. Cl. H04N 5/232; H04N 5/33; G01J 5/30

(52) U.S. Cl. CPC H04N 5/23229; G01J 5/30; H04N 5/33; H04N 5/23293; G01J 2005/0081

(57) ABSTRACT

Methods and systems for pixel by pixel thermography for a thermal imaging system with a Focal Plane Array (FPA), a shutter for subjecting the FPA to a flat field scene and a temperature sensor which reads the temperature of the system including the flat field scene temperature, including determining the flux expected from the flat field scene from the value of the temp sensor and flux versus temperature curves, black-body curves, presenting the FPA with the flat field scene at the known temperature, at predetermined times during camera use, calculating a gain factor for each pixel relating the observed signal from each pixel to the expected flux, exposing the FPA to an actual scene, and using the actual flux observed and the gain factor relate each pixel's signal to temperature using flux versus temperature blackbody curves.

### CROSS-REFERENCE TO RELATED APPLICATIONS

This application claims the benefit of priority from U.S. Prov. App'n No. 62/043,005, filed Aug. 28, 2014, entitled “Image Display and Thermography for a Thermal Imaging Camera,” which is incorporated by reference herein in its entirety.

### BACKGROUND

1. Field

The specification relates to thermography for imaging systems, such as cameras including infrared cameras for thermal imaging systems, and in particular to systems and methods for determining and/or displaying scene temperature.

2. Description of Related Art

The increasing availability of high-performance, low-cost uncooled infrared imaging devices, such as bolometer focal plane arrays (FPAs), is enabling the design and production of mass-produced, consumer-oriented infrared (IR) cameras capable of quality thermal imaging. Such thermal imaging sensors have long been expensive and difficult to produce, thus limiting the employment of high-performance, long-wave imaging to high-value instruments, such as aerospace, military, or large-scale commercial applications. Mass-produced IR cameras may have different design requirements than complex military or industrial systems. New approaches for providing quantitative information for parameters such as temperature at a given location of a scene in an image may be desirable for low-cost, mass-produced systems.

### SUMMARY

Example embodiments described herein have innovative features, no single one of which is indispensable or solely responsible for their desirable attributes. Without limiting the scope of the claims, some of the advantageous features will now be summarized.

In a first aspect, a method is provided for performing thermography using individual photodetectors of an imaging system comprising a shutter, an array of photodetectors, and a temperature sensor associated with the imaging system. The method includes determining an expected flux from a flat field scene at a known temperature, the expected flux being determined based at least in part on the determined calibrated temperature and functions relating observed flux or signal at a photodetector to the known temperature. The method includes acquiring from the array of photodetectors image data of a flat field scene at a known temperature during a first time period, the image data comprising an array of pixel values. The method includes calculating gain factors for individual pixels, the gain factors relating the observed signal to the expected flux. The method includes acquiring from the array of photodetectors image data of a scene at a time after the first time period. The method includes determining temperatures for individual pixels using the actual observed flux at the individual pixels and their associated gain factors by relating signals from the individual pixels to temperature using functions relating flux to temperature, the functions being derived from blackbody curves.

In some embodiments of the first aspect, the method further includes calibrating the temperature sensor prior to camera use by exposing the imaging system to a known temperature; observing the temperature sensor value; and using the calibrated temperature to determine flat field flux.

In some embodiments of the first aspect, the method further includes calibrating the flux observed by individual photodetectors when exposed to controlled temperature flat field scenes at a plurality of temperatures using a calibration source, developing a flux dependent gain factor for each pixel, and applying this factor when determining scene temperature during operation of the imaging system. In a further embodiment, the method further includes acquiring from the array of photodetectors image data of a flat field scene with the shutter closed, determining a temperature of the shutter based on temperature measurements provided by the temperature sensor, adjusting the gain factors so that a conversion of output from an individual pixel to temperature results in a temperature that is substantially similar to the determined temperature of the shutter, acquiring from the array of photodetectors image data of a scene, and determining temperatures for individual pixels using the adjusted gain factors.

In some embodiments of the first aspect, scene temperatures at one or more photodetectors are displayed numerically on a display adjacent to corresponding pixels on the display.

In a second aspect, a method is provided for performing thermography using individual photodetectors of an imaging system comprising a shutter, an array of photodetectors, and a temperature sensor associated with the imaging system. The method includes calibrating a flux observed by individual photodetectors when exposed to controlled temperature flat field scenes at a plurality of temperatures using a calibration source. The method includes developing a gain factor for individual pixels, the gain factor used to convert between pixel output and a temperature value. The method includes acquiring from the array of photodetectors image data of a flat field scene with a shutter closed during operation of the imaging system. The method includes determining a temperature of the shutter based on temperature measurements provided by the temperature sensor. The method includes adjusting the gain factors of the individual pixels so that a conversion of output from an individual pixel to a temperature value results in a temperature value that is substantially similar to the determined temperature of the shutter. The method includes acquiring from the array of photodetectors image data of a scene. The method includes determining temperature values corresponding to output from individual pixels using the adjusted gain factors.

In some embodiments of the second aspect, scene temperatures at one or more photodetectors are displayed numerically on a display adjacent to corresponding pixels on the display. In some embodiments of the second aspect, the gain factors are used in functions relating flux to temperature, the functions being derived from blackbody curves.

In a third aspect, a thermal imaging system is provided that includes an imaging array comprising an infrared focal plane array, the infrared focal plane array comprising an array of microbolometers, each pixel of the focal plane array including a microbolometer photodetector. The thermal imaging system includes a temperature sensor configured to provide a signal corresponding to a temperature of the imaging array. The thermal imaging system includes a system controller configured to determine a temperature value for individual pixels, the temperature value corresponding to output of the individual pixels. The system controller configured to calibrate a flux observed by individual photodetectors when exposed to controlled temperature flat field scenes at a plurality of temperatures using a calibration source; develop at least one gain factor for individual pixels, the gain factor used to convert between pixel output and a temperature value; acquire from the array of photodetectors image data of a flat field scene with a shutter closed during operation of the imaging system; determine a temperature of the shutter based on temperature measurements provided by the temperature sensor; adjust the gain factors of the individual pixels so that a conversion of output from an individual pixel to a temperature value results in a temperature value that is substantially similar to the determined temperature of the shutter; acquire from the array of photodetectors image data of a scene; and determine temperature values corresponding to output from individual pixels using the adjusted gain factors.

In some embodiments of the third aspect, the temperature sensor is mounted on a printed circuit board. In some embodiments of the third aspect, the infrared focal plane array is on a die and the temperature sensor is incorporated onto the same die as the focal plane array. In some embodiments of the third aspect, the gain factors are used in functions relating flux to temperature, the functions being derived from blackbody curves.

In some embodiments of the third aspect, the system controller is further configured to calibrate a flux observed by individual microbolometers when exposed to controlled temperature flat field scenes at a plurality of temperatures using a calibration source, develop a gain factor for each microbolometer, and apply the gain factor when determining scene temperature during operation of the imaging system. In a further embodiment, the system controller is further configure to acquire from the array of microbolometers image data of a flat field scene with the shutter closed, determine a temperature of the shutter based on temperature measurements provided by the temperature sensor, adjust the gain factors so that a conversion of output from an individual microbolometer to temperature results in a temperature that is substantially similar to the determined temperature of the shutter, acquire from the array of microbolometers image data of a scene, and determine temperatures for individual microbolometer using the adjusted gain factors.

In some embodiments of the third aspect, the thermal imaging system further includes a display configured to display the acquired image data. In a further embodiment, the system controller is further configured to numerically display scene temperatures for individual microbolometers, the scene temperatures displayed adjacent to corresponding pixels on the display.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure.

FIG. 1A illustrates a functional block diagram of an example imaging system.

FIG. 1B illustrates a functional block diagram of the example imaging system illustrated in FIG. 1A, wherein functionality of the imaging system is divided between a camera and a mobile electronic device.

FIGS. 2A and 2B illustrate an example embodiment of an infrared camera core.

FIGS. 3A and 3B illustrate exemplary general operation of a shutter in an imaging system.

FIG. 4 illustrates a functional block diagram of a thermography system.

FIG. 5 illustrates a flow chart of an example method for performing thermography in a thermal imaging system.

### DETAILED DESCRIPTION

Generally described, aspects of the present disclosure relate to thermography in a thermal imaging system. Thermography as disclosed herein can be configured to accurately determine temperatures based on observed flux measurements at pixels in the thermal imaging system. The present disclosure includes systems and methods to determine temperatures based on predicted or expected fluxes at a pixel and temperature measurements of the thermal imaging system. Adjustment factors can be used to improve temperature accuracy, wherein the adjustment factors can be configured to account for pixel gain and differences between separate thermal imaging systems. Thus, in some embodiments, the disclosed systems and methods can accurately determine temperature using low-cost, mass-produced thermal imagers.

Although examples and implementations described herein focus, for the purpose of illustration, on implementation in an infrared camera core using a focal plane array with microbolometers the systems and methods disclosed, herein can be implemented in other thermographic environments. Various aspects of the disclosure will now be described with regard to certain examples and embodiments, which are intended to illustrate but not limit the disclosure.

A thermal imaging system can be configured to generate an image of a scene, where relative intensities within the scene correspond to relative temperature differences. These images of relative temperature may be beneficial for many uses. However, it may also be advantageous to determine the actual temperature of items in the imaged scene. The process for determining these actual temperatures is generally known as thermography. When thermography is performed for a small region of a scene, that process is generally known as spot thermography. Thermography for a thermal imaging camera involves correlating the radiation flux measured by a thermal detector (e.g., long-wave infrared radiation having wavelengths between about 7 μm and about 15 μm) with the radiation flux expected from an emission source at a particular temperature. Since the wavelength peak of the black body curve of objects between freezing and boiling water in temperature (most of the content in many thermal image scenes) is in this long wave thermal region, it is theoretically possible to correlate flux detected with quantitative temperature. However the tools needed to perform this correlation may not be present, so the disclosed techniques can be implemented to provide quantitative thermography with mass-produced thermal imagers.

One or more embodiments may provide for accurate thermography for a thermal image derived from a thermal imaging camera.

The disclosed methods for thermography may be implemented as modules that may be a programmed computer method or a digital logic method and may be implemented using a combination of any of a variety of analog and/or digital discrete circuit components (transistors, resistors, capacitors, inductors, diodes, etc.), programmable logic, microprocessors, microcontrollers, application-specific integrated circuits, or other circuit elements. A memory configured to store computer programs or computer-executable instructions may be implemented along with discrete circuit components to carry out one or more of the methods described herein. In certain implementations, the disclosed methods may be implemented in conjunction with a focal plane array (FPA) on a camera core, wherein the processor and memory components executing the disclosed methods may be on a device mated to the camera core, such as a mobile appliance including smart phones, tablets, personal computers, etc. In some implementations, the processing and memory elements of the imaging system may be in programmable logic or on-board processors that are part of the core or camera system. In some embodiments, thermography may be accomplished on a processing element on the camera core, and further image processing and display may be accomplished by a system controller mated to the core.

As a particular example of some advantages provided by the disclosed systems and methods, an imaging system can include a focal plane array (FPA) configured to acquire images of a scene. The FPA can include a two-dimensional array of N detectors, the FPA configured to output a two-dimensional image of the scene. For imaging purposes, image frames, typically data from all or some of the detectors N_{f}, are produced by the FPA, each successive frame containing data from the array captured in successive time windows. Thus, a frame of data delivered by the FPA comprises N_{f} digital words, each word representing a particular pixel, P, in the image. These digital words are usually of a length determined by the analog to digital conversion (A/D) process. For example, if the pixel data is converted with a 14 bit A/D, the pixel words may be 14 bits in length, and there may be 16384 counts per word. For an IR camera used as a thermal imaging system, these words may correspond to an intensity of radiation measured by each pixel in the array. In a particular example, for a bolometer IR FPA the intensity per pixel usually corresponds to temperature of the corresponding part of the imaged scene, with lower values corresponding to colder regions and higher values to hotter regions. It may be desirable to display this data on a visual display.

Each pixel in an FPA may include a radiation detector that generates relatively small signals in response to detected radiation, such as in an infrared imaging array. These signals may be relatively small compared to signals or signal levels in the FPA arising from sources not caused by incident radiation, or non-image signals, wherein these non-image signals are related to the materials, structure, and/or components of the FPA. For example, pixels in an FPA can include interface circuitry including resistor networks, transistors, and capacitors on a read out integrated circuit (ROIC) that may be directly interfaced to the array of detectors. For instance, a microbolometer detector array, a microelectrical mechanical system (MEMS) device, may be manufactured using a MEMS process. The associated ROIC, however, may be fabricated using electronic circuit techniques. These two components can be combined together to form the FPA.

### Example Imaging Systems

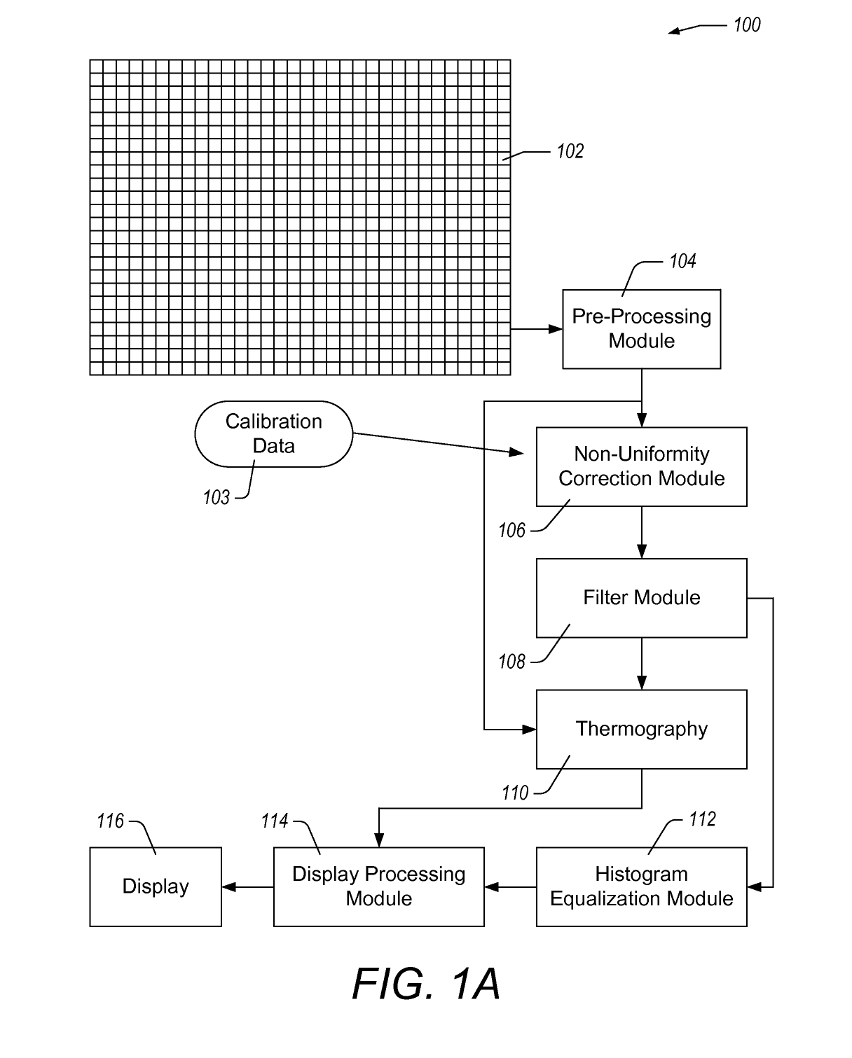

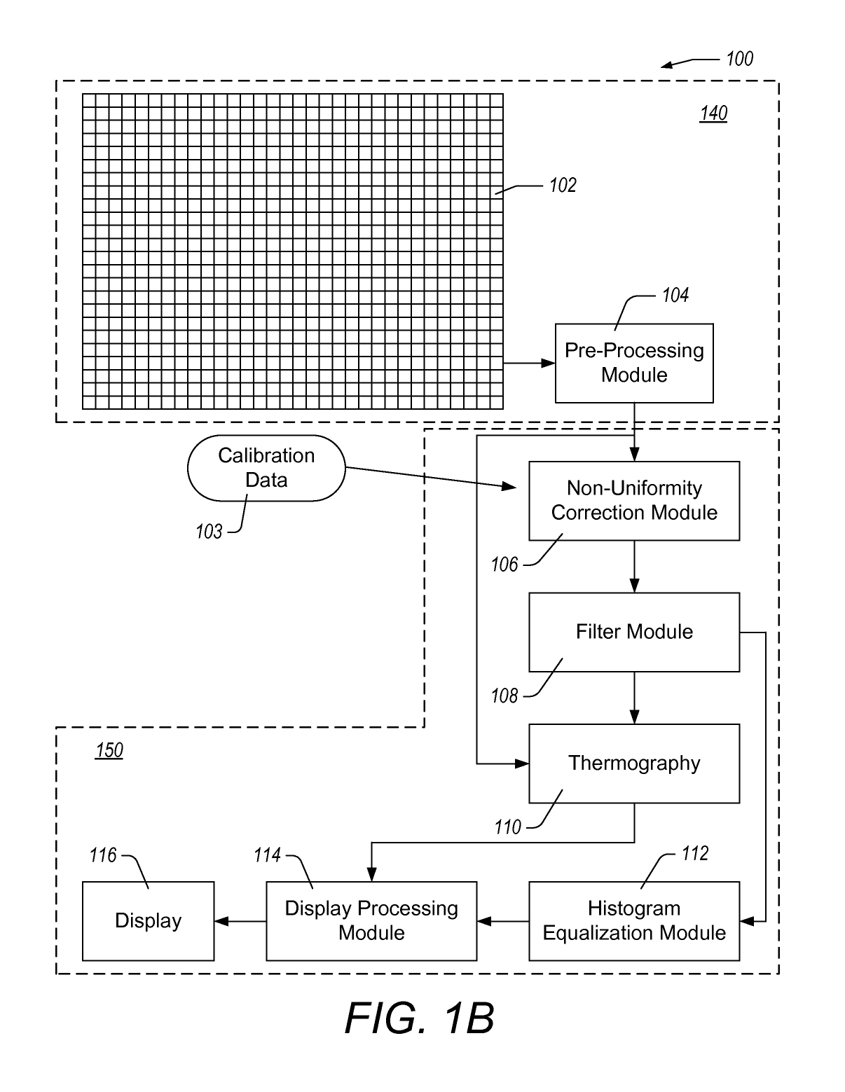

FIG. 1A illustrates a functional block diagram of an imaging system 100 comprising an image sensor such as a focal plane array 102, a pre-processing module 104, a non-uniformity correction module 106, a filter module 108, a thermography module 110, a histogram equalization module 112, a display processing module 114, and a display 116. The focal plane array 102 can output a sequence of frames of intensity data (e.g., images, thermal images, etc.). Each frame can include an array of pixel values, each pixel value representing light intensity detected by a corresponding pixel on the focal plane array 102. The pixel values can be read out of the focal plane array 102 as a stream of serial digital data. In some embodiments, the pixel values are read out of the focal plane array 102 using read out electronics that process whole rows or whole columns of the focal plane array 102. The format of the stream of data can be configured to conform to a desired, standard, or pre-defined format. The stream of digital data can be displayed as a two-dimensional image, such as by the display 116.

In some embodiments, the focal plane array 102 can be an array of microbolometers integrated with a read out integrated circuit (“ROIC”). The array of microbolometers can be configured to generate electrical signals in response to a quantity of thermal radiation or a temperature. The ROIC can include buffers, integrators, analog-to-digital converters, timing components, and the like to read the electrical signals from the array of microbolometers and to output a digital signal (e.g., 14-bit serial data separated into image frames). Additional examples of systems and methods associated with the focal plane array 102 are disclosed in U.S. patent application Ser. No. 14/292,124, entitled “Data Digitization and Display for an Imaging System,” filed May 30, 2014, the entire contents of which is incorporated by reference herein.

The focal plane array 102 can have calibration or other monitoring information associated with it (e.g., calibration data 103) that can be used during image processing to generate a superior image. For example, calibration data 103 may include bad pixel maps and/or gain tables stored in data storage and retrieved by modules in the imaging system 100 to correct and/or adjust the pixel values provided by the focal plane array 102. Calibration data 103 may include gain tables. As described herein, the focal plane array 102 can include a plurality of pixels with integrated read out electronics. The read out electronics can have a gain associated with it, wherein the gain may be proportional to the transimpedance of a capacitor in the electronics. This gain value, which may in some implementations take the form of a pixel gain table, may be used by the image processing modules of the imaging system 100. Additional examples of calibration data for the imaging system 100 are described in U.S. patent application Ser. No. 14/829,490, entitled “Gain Calibration for an Imaging System,” filed Aug. 18, 2015, the entire contents of which is incorporated by reference herein. The calibration data 103 can be stored on the imaging system 100 or in data storage on another system for retrieval during image processing.

The imaging system 100 includes one or more modules configured to process image data from the focal plane array 102. One or more of the modules of the imaging system 100 can be eliminated without departing from the scope of the disclosed embodiments. The following modules are described to illustrate the breadth of functionality available to the disclosed imaging systems and not to indicate that any individual module or described functionality is required, critical, essential, or necessary.

The imaging system 100 includes the pre-processing module 104. The pre-processing module 104 can be configured to receive the digital data stream from the focal plane array 102 and to perform pre-processing functions. Examples of such functions include frame averaging, high-level frame-wide filtering, etc. The pre-processing module 104 can output serial digital data for other modules.

As an example, the pre-processing module 104 can include conditional summation functionality configured to implement integration and averaging techniques to increase apparent signal to noise in image data. For example, the conditional summation functionality can be configured to combine successive frames of digitized image data to form a digitally integrated image. This digitally integrated image can also be averaged to reduce noise in the image data. The conditional summation functionality can be configured to sum values from successive frames for each pixel from the focal plane array 102. For example, the conditional summation functionality can sum the values of each pixel from four successive frames and then average that value. In some implementations, the conditional summation functionality can be configured to select a best or preferred frame from successive frames rather than summing the successive frames. Examples of these techniques and additional embodiments are disclosed in U.S. patent application Ser. No. 14/292,124, entitled “Data Digitization and Display for an Imaging System,” filed May 30, 2014, the entire contents of which is incorporated by reference herein.

As another example, the pre-processing module 104 can include adaptive resistor digital to analog converter (“RDAC”) functionality configured to determine and/or adjust for operating bias points of the focal plane array 102. For example, for an imaging system that includes a shutter, the imaging system 100 can be configured to adjust an operating bias point of the detectors in the focal plane array 102. The adaptive RDAC functionality can implement an adaptive operating bias correction method that is based at least in part on periodic measurement of a flat field image (e.g., an image acquired with the shutter closed). The adaptive RDAC functionality can implement an ongoing adjustment of the operating bias based at least in part on a measured or detected drift over time of the flat field image. The bias adjustment provided by the adaptive RDAC functionality may provide compensation for drift over time of the photodetectors and electronics due to effects such as temperature changes. In some embodiments, the adaptive RDAC functionality includes an RDAC network that can be adjusted to bring measured flat field data closer to a reference bias level. Additional examples of systems and methods related to the adaptive RDAC functionality are described in greater detail in U.S. patent application Ser. No. 14/829,500, filed Aug. 18, 2015, entitled “Adaptive Adjustment of the Operating Bias of an Imaging System,” the entire contents of which is incorporated by reference herein.

After the pre-processing module 104, other processing modules can be configured to perform a series of pixel-by-pixel or pixel group processing steps. For example, the image processing system 100 includes a non-uniformity correction module 106 configured to adjust pixel data for gain and offset effects that are not part of the image scene itself, but are artifacts of the sensor. For example, the non-uniformity correction module 106 can be configured to receive a stream of digital data and correct pixel values for non-uniformities in the focal plane array 102. In some imaging systems, these corrections may be derived by intermittently closing a shutter over the focal plane array 102 to acquire uniform scene data. From this acquired uniform scene data, the non-uniformity correction module 106 can be configured to determine deviations from uniformity. The non-uniformity correction module 106 can be configured to adjust pixel data based on these determined deviations. In some imaging systems, the non-uniformity correction module 106 utilizes other techniques to determine deviations from uniformity in the focal plane array. Some of these techniques can be implemented without the use of a shutter. Additional examples of systems and methods for non-uniformity correction are described in U.S. patent application Ser. No. 14/817,847, entitled “Time Based Offset Correction for Imaging Systems,” filed Aug. 4, 2015, the entire contents of which is incorporated by reference herein.

After the pre-processing module 104, the imaging system 100 can include a high/low Cᵢₙₜ signal processing functionality configured to receive a stream of digital data (e.g., 14-bit serial data) from the pre-processing module 104. The high/low Cᵢₙₜ functionality can be configured to process the stream of digital data by applying gain tables, for example, as provided in the calibration data 103. The high/low Cᵢₙₜ functionality can be configured to process the stream of digital data using output of high/low integration components. Such high/low integration components can be integrated with the ROIC associated with the focal plane array 102. Examples of the high/low integration components are described in U.S. patent application Ser. No. 14/292,124, entitled “Data Digitization and Display for an Imaging System,” filed May 30, 2014, the entire contents of which is incorporated by reference herein.

The image processing system 100 includes a filter module 108 configured to apply one or more temporal and/or spatial filters to address other image quality issues. For example, the read out integrated circuit of the focal plane array can introduce artifacts into an image, such as variations between rows and/or columns. The filter module 108 can be configured to correct for these row- or column-based artifacts, as described in greater detail in U.S. patent application Ser. No. 14/702,548, entitled “Compact Row Column Noise Filter for an Imaging System,” filed May 1, 2015, the entire contents of which is incorporated by reference herein. The filter module 108 can be configured to perform corrections to reduce or eliminate effects of bad pixels in the image, enhance edges in the image data, suppress edges in the image data, adjust gradients, suppress peaks in the image data, and the like.

For example, the filter module 108 can include bad pixel functionality configured to provide a map of pixels on the focal plane array 102 that do not generate reliable data. These pixels may be ignored or discarded. In some embodiments, data from bad pixels is discarded and replaced with data derived from neighboring, adjacent, and/or near pixels. The derived data can be based on interpolation, smoothing, averaging, or the like.

As another example, the filter module 108 can include thermal gradient functionality configured to adjust pixel values based on thermal gradients present in the image data but that are not part of the scene imaged by the imaging system 100. The thermal gradient functionality can be configured to use local flat scene data to derive data to improve image quality by correcting for thermal gradients produced in the imaging system 100. Examples of determining corrections for the thermal gradient functionality are described in greater detail in U.S. Prov. App'n No. 62/086,305, entitled “Image Adjustment Based on Locally Flat Scenes,” filed Dec. 2, 2014, the entire contents of which is incorporated by reference herein.

The filter module 108 can include peak limit functionality configured to adjust outlier pixel values. For example, the peak limit functionality can be configured to clamp outlier pixel values to a threshold value.

The filter module 108 can be configured to include an adaptive low-pass filter and/or a high-pass filter. In some embodiments, the imaging system 100 applies either the adaptive low-pass filter or the high-pass filter, but not both. The adaptive low-pass filter can be configured to determine locations within the pixel data where it is likely that the pixels are not part of an edge-type image component. In these locations, the adaptive low-pass filter can be configured to replace pixel data with smoothed pixel data (e.g., replacing pixel values with the average or median of neighbor pixels). This can effectively reduce noise in such locations in the image. The high-pass filter can be configured to enhance edges by producing an edge enhancement factor that may be used to selectively boost or diminish pixel data for the purpose of edge enhancement Additional examples of adaptive low-pass filters and high-pass filters are described in U.S. patent application Ser. No. 14/817,989, entitled “Local Contrast Adjustment for Digital Images,” filed Aug. 4, 2015, the entire contents of which is incorporated by reference herein.

The filter module 108 can be configured to apply optional filters to the image data. For example, optional filters can include, without limitation, averaging filters, median filters, smoothing filters, and the like. The optional filters can be turned on or off to provide targeted or desired effects on the image data.

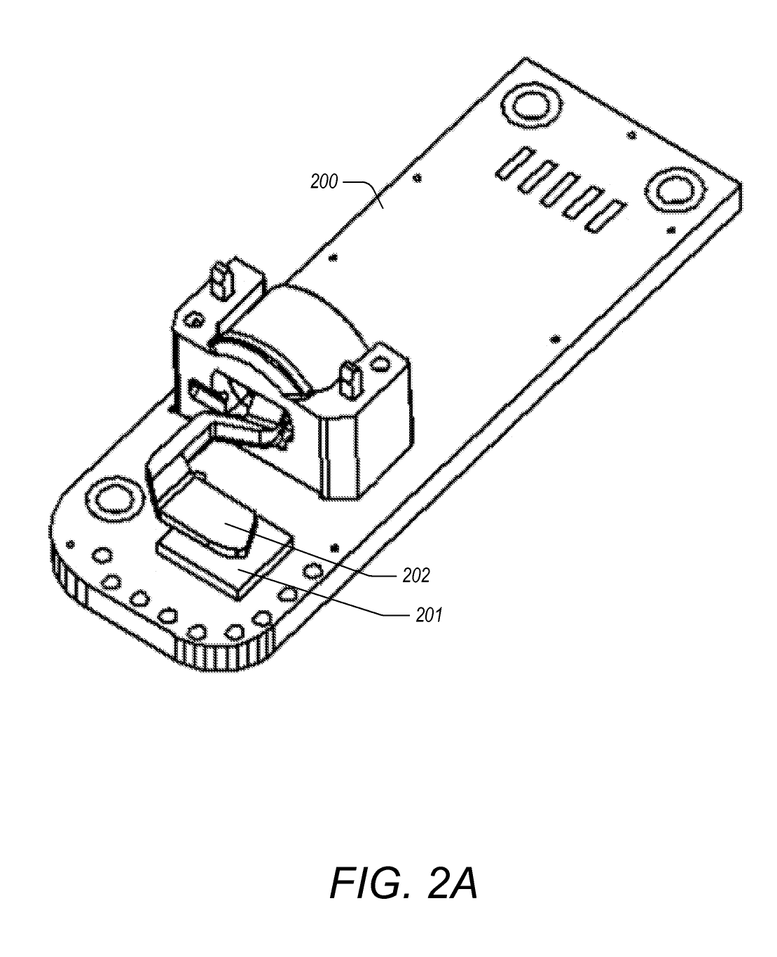

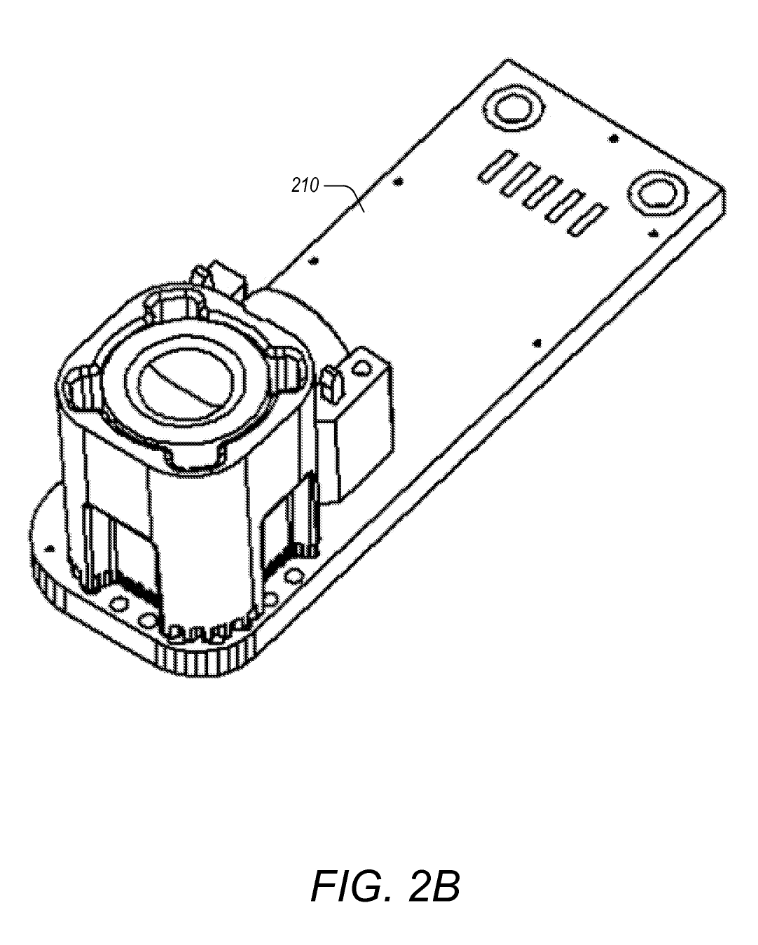

The image processing system 100 includes a thermography module 110 configured to convert intensity to temperature. The light intensity can correspond to intensity of light from a scene and/or from objects in a field of view of the imaging system 100. The thermography module 110 can be configured to convert the measured light intensities to temperatures corresponding to the scene and/or objects in the field of view of the imaging system 100. The thermography module 110 can receive as input calibration data (e.g., calibration data 103). The thermography module 110 may also use as inputs raw image data (e.g., pixel data from the pre-processing module 104) and/or filtered data (e.g., pixel data from the filter module 108). Examples of thermography modules and methods are described in greater detail herein with reference to FIGS. 2A-6.

The image processing system 100 includes a histogram equalization module 112, or other display conversion module, configured to prepare the image data for display on the display 116. In some imaging systems, the digital resolution of the pixel values from the focal plane array 102 can exceed the digital resolution of the display 116. The histogram equalization module 112 can be configured to adjust pixel values to match the high resolution value of an image or a portion of an image to the lower resolution of the display 116. The histogram module 112 can be configured to adjust pixel values of the image in a manner that avoids using the limited display range of the display 116 on portions of the image where there is little or no data. This may be advantageous for a user of the imaging system 100 when viewing images acquired with the imaging system 100 on the display 116 because it can reduce the amount of display range that is not utilized. For example, the display 116 may have a digital brightness scale, which for an infrared image corresponds to temperature where higher intensity indicates a higher temperature. However, the display brightness scale, for example a grey scale, is generally a much shorter digital word than the pixel sample words. For instance, the sample word of the pixel data may be 14 bits while a display range, such as grey scale, can be typically 8 bits. So for display purposes, the histogram equalization module 112 can be configured to compress the higher resolution image data to fit the display range of the display 116. Examples of algorithms and methods that may be implemented by the histogram equalization module 112 are disclosed in U.S. patent application Ser. No. 14/292,124, entitled “Data Digitization and Display for an Imaging System,” filed May 30, 2014, the entire contents of which is incorporated by reference herein.

The imaging system 100 includes a display processing module 114 configured to prepare the pixel data for display on the display 116 by, for example, selecting color sables to convert temperatures and/or pixel values to color on a color display. As an example, the display processing module can include a colorizer lookup table configured to convert pixel data and/or temperature data into color images for display on the display 116. The colorizer lookup table can be configured to display different temperatures of a thermally imaged scene using different color display lookup tables depending at least in part on the relationship of a temperature of a given scene to a threshold temperature. For example, when a thermal image of a scene is displayed, various temperatures of the scene may be displayed using different lookup tables depending on their relationship to the input temperature. In some embodiments, temperatures above, below, or equal to an input temperature value may be displayed using a color lookup table, while other temperatures may be displayed using a grey scale lookup table. Accordingly, the colorizer lookup table can be configured to apply different colorizing lookup tables depending on temperature ranges within a scene in combination with user preferences or selections. Additional examples of functionality provided by a display processing module are described in U.S. Prov. App'n No. 62/049,880, entitled “Selective Color Display of a Thermal Image,” filed Sep. 12, 2014, the entire contents of which is incorporated herein by reference in its entirety.

The display 116 can be configured display the processed image data. The display 116 can also be configured to accept input to interact with the image data and/or to control the imaging system 100. For example, the display 116 can be a touchscreen display.

The imaging system 100 can be provided as a standalone device, such as a thermal sensor. For example, the imaging system 100 can include an imaging system housing configured to enclose hardware components (e.g., the focal plane array 102, read out electronics, microprocessors, data storage, field programmable gate arrays and other electronic components, and the like) of the imaging system 100. The imaging system housing can be configured to support optics configured to direct light (e.g., infrared light, visible light, etc.) onto the image sensor 102. The housing can include one or more connectors to provide data connections from the imaging system 100 to one or more external systems. The housing can include one or more user interface components to allow the user to interact with and/or control the imaging system 100. The user interface components can include, for example and without limitation, touch screens, buttons, toggles, switches, keyboards, and the like.

In some embodiments, the imaging system 100 can be part of a network of a plurality of imaging systems. In such embodiments, the imaging systems can be networked together to one or more controllers.

FIG. 1B illustrates a functional block diagram of the example imaging system 100 illustrated in FIG. 1A, wherein functionality of the imaging system 100 is divided between a camera or sensor 140 and a mobile electronic device 150. By dividing image acquisition, pre-processing, signal processing, and display functions among different systems or devices, the camera 140 can be configured to be relatively low-power, relatively compact, and relatively computationally efficient compared to an imaging system that performs a majority or all of such functions on board. As illustrated in FIG. 1B, the camera 140 is configured to include the focal plane array 102 and the pre-processing module 104. In some embodiments, one or more of the modules illustrated as being part of the mobile electronic device 150 can be included in the camera 140 instead of in the mobile electronic device 150. In some embodiments, certain advantages are realized based at least in part on the division of functions between the camera 140 and the mobile electronic device 150. For example, some pre-processing functions can be implemented efficiently on the camera 140 using a combination of specialized hardware (e.g., field-programmable gate arrays, application-specific integrated circuits, etc.) and software that may otherwise be more computationally expensive or labor intensive to implement on the mobile electronic device 150. Accordingly, an aspect of at least some of the embodiments disclosed herein includes the realization that certain advantages may be achieved by selecting which functions are to be performed on the camera 140 (e.g., in the pre-processing module 104) and which functions are to be performed on the mobile electronic device 150 (e.g., in the thermography module 110).

An output of the camera 140 can be a stream of digital data representing pixel values provided by the pre-processing module 104. The data can be transmitted to the mobile electronic device 150 using electronic connectors (e.g., a micro-USB connector, proprietary connector, etc.), cables (e.g., USB cables, Ethernet cables, coaxial cables, etc.), and/or wirelessly (e.g., using BLUETOOTH, Near-Field Communication, Wi-Fi, etc.). The mobile electronic device 150 can be a smartphone, tablet, laptop, or other similar portable electronic device. In some embodiments, power is delivered to the camera 140 from the mobile electronic device 150 through the electrical connectors and/or cables.

The imaging system 100 can be configured to leverage the computing power, data storage, and/or battery power of the mobile electronic device 150 to provide image processing capabilities, power, image storage, and the like for the camera 140. By off-loading these functions from the camera 140 to the mobile electronic device 150, the camera can have a cost-effective design. For example, the camera 140 can be configured to consume relatively little electronic power (e.g., reducing costs associated with providing power), relatively little computational power (e.g., reducing costs associated with providing powerful processors), and/or relatively little data storage (e.g., reducing costs associated with providing digital storage on the camera 140). This can reduce costs associated with manufacturing the camera 140 due at least in part to the camera 140 being configured to provide relatively little computational power, data storage, and/or power, because the imaging system 100 leverages the superior capabilities of the mobile electronic device 150 to perform image processing, data storage, and the like.

### Example Thermal Imaging System Configured for Accurate Thermography

FIGS. 2A and 2B illustrate an exemplary camera core, the camera core 200 being partially assembled (as illustrated in FIG. 2A) and the camera core 210 being a fully assembled core. A focal plane array (FPA) 201 is positioned on the core 200 relative to shutter 202, such that the shutter 202 can be actuated to expose and to occlude the FPA 201. Various interface electronics may be part of the camera core 200 or part of a controller mated to the core 200.

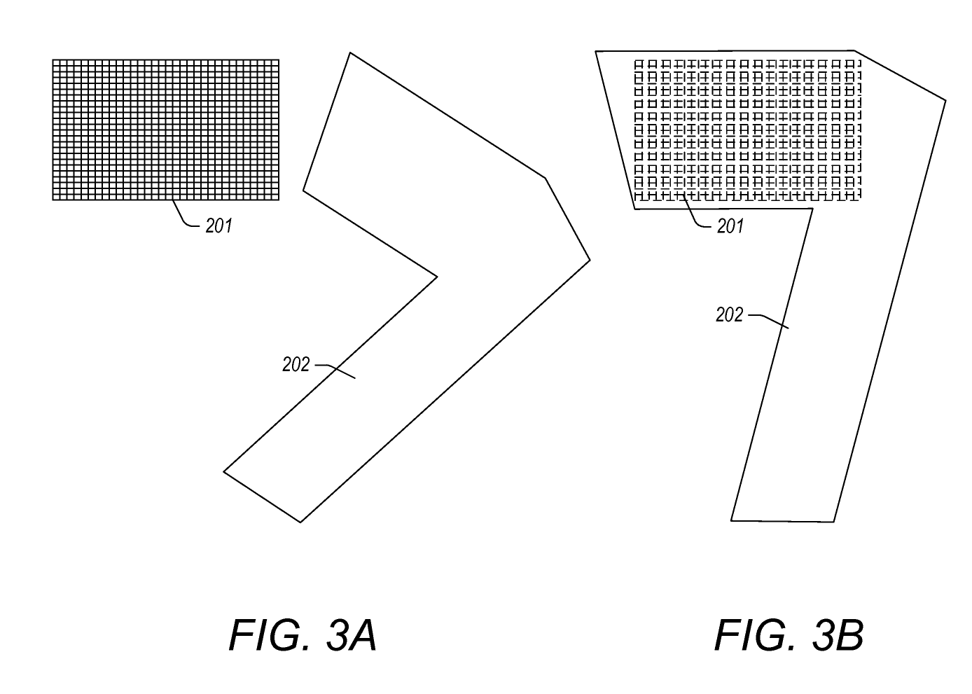

FIGS. 3A and 3B illustrate an example shutter 202 and an example FPA 201, with the shutter 202 exposing the FPA 201 (illustrated in FIG. 3A) and occluding the FPA 201 (illustrated in FIG. 3B). When the shutter 202 occludes the FPA 201, the shutter 202 can be said to be closed. In the closed position, the shutter 202 can be configured to cover the entire field of view of the FPA 201. Arrangements for selectively exposing the FPA 201 to a flat field scene are possible other than moving a shutter flag. For instance, a mirror may be rotated to expose the FPA 201 to a flat scene. As another example, an electro-optical cell that can be alternated between opaque and transparent states to selectively expose and occlude the FPA 201. As used herein, opening a shutter and closing a shutter should be respectively understood to include exposing the FPA 201 to an image scene and exposing the FPA 201 to a flat field scene. In the closed position, image data can be acquired by the FPA 201. This acquired image data with the shutter 202 closed can be equivalent or similar to a flat field image of a dark field of view for a visible light imaging system or a cooled infrared imaging system. For an uncooled IR imager, images acquired with the shutter 202 closed may be equivalent or similar to a flat field image at a temperature of the shutter 202.

Flat field scenes and images can be used in thermography to measure pixel output when the pixel is exposed to a known temperature. In general, a flat field scene can generally refer to a substantially uniform scene provided for an imaging sensor. Similarly, a flat field image can generally refer to image data of a flat field scene. For an uncooled infrared imager, the shutter 202 may radiate infrared light with an intensity corresponding to a temperature of the shutter 202. Thus, with the shutter 202 closed for an uncooled infrared imager, images acquired with the shutter 202 closed are generally flat field images with incident light intensity corresponding to a temperature of the shutter 202. A flat field image can be used in thermography by determining photodetector values in the flat field image data when exposed to a known temperature. Flat field images can be used to perform other operations in an imaging system, examples of which are described in greater detail in U.S. patent application Ser. 14/829,500, filed Aug. 18, 2015, entitled “Adaptive Adjustment of the Operating Bias of an Imaging System,” and U.S. patent application Ser. No. 14/817,847, entitled “Time Based Offset Correction for Imaging Systems,” filed Aug. 4, 2015, the entire contents of each of which is incorporated by reference herein.

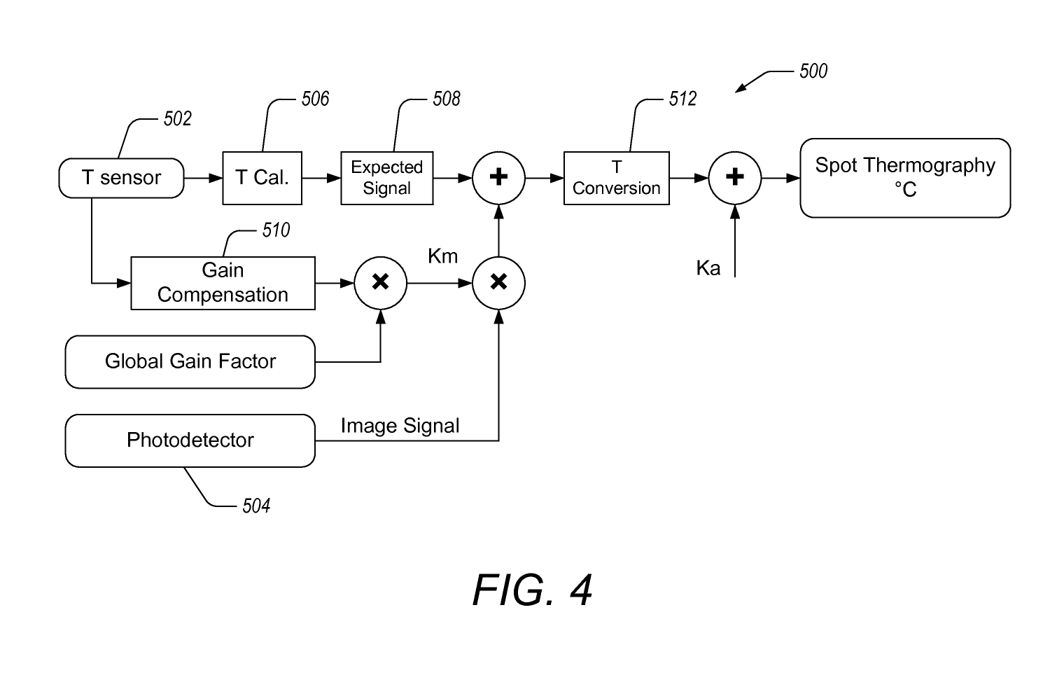

For uncooled infrared imagers, in certain implementations, images acquired with the shutter 202 in the closed position can be approximated as flat field images with an intensity corresponding to the temperature of the shutter 202. An imaging system can use this information along with information from temperature sensors to relate pixel output to a temperature of the portion of the scene imaged by the corresponding pixel. Relating flat field image scenes to temperature sensor measurements may beneficially be used in this manner due at least in part to the temperature of the shutter 202 behaving similarly to the temperature of the FPA 201 as measured by a temperature sensor on or near the FPA 201. For example, changes in the temperature of the shutter 202 track changes in the temperature of the FPA 201. Thus, using flat field images with the shutter 202 closed in uncooled infrared imagers allows for measurements to be made that correlate pixel response to temperature of a scene, as described in greater detail herein with reference to FIG. 4.

### Examples of Performing Thermography in a Thermal Imaging System

An example photodetector circuit includes a photodetector (e.g., a microbolometer) configured to produce an output signal that corresponds to the intensity of radiation intensity incident on photodetector. The circuit includes a network of resistors configured to provide a tailored operating bias to individual photodetectors in the imaging array. The network of resistors can be used to set tailored operating biases for each photodetector in the imaging array. The output signal of the photodetector can be delivered to an analog-to-digital converter to convert the pixel data to digital data. The digital data can be delivered to a processing element, such as a system controller.

The circuit includes a temperature sensor. In some embodiments, the temperature sensor can be included in a different location in a thermal camera, such as on a printed circuit board. Depending at least in part on the location of the temperature sensor, various thermogmphy approaches may be employed. For example, when the temperature sensor is on the FPA, measurements provided by the temperature sensor may be an accurate reading of the temperature of the FPA due at least in part to the FPA being implemented as a compact integrated circuit die. In such a configuration, the temperature sensor can be integrated directly onto the die and can measure temperature accurately for the entire die.

Where the temperature sensor is on the FPA, the shutter can be treated effectively as a blackbody with a known temperature, the known temperature being the same or substantially the same as the reading of the temperature sensor. Since the temperature of the FPA varies with time both due to warm-up and to ambient temperature changes, a plurality of measurements can be made of photodetector output as a function of temperature of the FPA and/or shutter. These measurements can be determined and updated during actual use of the camera to characterize photodetector response as a function of FPA temperature and/or scene temperature. Since most thermal cameras undergo initial testing or calibration at different temperatures, temperature data can be acquired to calibrate the temperature sensor. For example, an FPA can be exposed to a controlled ambient temperature and readings can be acquired from the temperature sensor. This can be repeated for a number of ambient temperatures to characterize the response of the temperature sensor to various temperatures. Characterizing and/or calibrating the temperature sensor may be advantageous because the response of photodetectors in an FPA, particularly for many types of thermal sensors such as microbolometers, may depend on scene temperature as well as ambient temperature. This dependence on ambient temperature may arise because the responsivity of microbolometers, as well as other photodetectors, shifts with the temperature of the detector.

By way of example, during an initial testing phase the FPA can be tested while it is still part of a wafer using a wafer prober, as described in greater detail in U.S. Prov. Pat. App'n No. 62/043,020, entitled “Radiometric Test and Configuration of an Infrared Focal Plane Array at Wafer Probe,” filed Aug. 28, 2014, which is incorporated by reference herein in its entirety. The wafer prober can include a wafer chuck that can provide a temperature-controlled base configured to maintain a targeted temperature for the entire wafer. This temperature can be changed to accomplish die testing at varying ambient temperatures. Using this configuration, an on-board temperature sensor (e.g., a temperature sensor mounted on the die) can be calibrated at a plurality of temperatures.

If the temperature sensor is located somewhere other than on the FPA, it may be possible to relate measurements from the temperature sensor to the temperature of the FPA although the FPA may undergo more rapid temperature changes than larger mechanical structures of a camera. However, if the temperature sensor is located somewhere else in the mechanical structure, then its readings may be treated as being close to the temperature of the shutter in the thermal imaging system. Thus, flat field image data acquired with the shutter closed may provide measurements that are substantially equivalent to a flat field image provided by a blackbody at the temperature indicated by the temperature sensor. The flat field image data may also be used to calibrate between measured signals from photodetectors to blackbody temperature. This data may be acquired at multiple points for different ambient temperatures either during testing or during operation of the camera. Advantageously, using the shutter to generate flat field image data for thermography purposes can provide information for all pixels on the FPA. In certain implementations, this can allow measurement of pixel-to-pixel variations.

In certain implementations, thermography can be accomplished using calibration data acquired during a testing phase of the FPA. This calibration data can be acquired by exposing the FPA to controlled temperature scenes, such as by filling the field of view of the FPA with the active area of a variable temperature blackbody. Such a calibration may also be performed by a user with a suitable calibration source (e.g., a flat field scene at a known temperature). This calibration may be supplemented and updated during use by employing the techniques described herein using the shutter.

FIG. 4 illustrates a functional block diagram of a thermography system 500 configured to provide thermographic measurements that address various sources of uncertainty or error in determining temperature. The thermography system 500 includes a mixture of hardware and software components configured to receive electrical signals corresponding to photodetector measurements, process those signals, and to produce modified electrical signals corresponding to temperature measurements.

The thermography system 500 can be calibrated during an initial testing phase to enable conversion from photodetector signal to temperature for a range of scene temperatures and at a variety of ambient temperatures. As described herein, photodetector response is a function of scene temperature (e.g., the temperature of the scene being imaged by the photodetector or the intensity of infrared radiation from a scene) as well as an operating temperature or a temperature of the focal plane array (e.g., an ambient temperature). As ambient temperature changes the photodetector response can change. For example, for a scene at a fixed temperature, photodetector response can change if a temperature of the FPA changes. At a fixed ambient temperature, photodetector response as a function of scene temperature can be determined For example, data can be acquired at two or more scene temperatures to characterize the photodetector response as a function of scene temperature. This may be done at a plurality of ambient temperatures, as well. For example, the FPA can be exposed to a flat field scene at a first tailored temperature and to a flat field scene at a second tailored temperature. Additional temperatures may also be used. A curve can be fit to the data points acquired at these two or more temperatures. This curve can be determined based on an analysis of blackbody curves and photodetector responsivity. Using this curve, the thermography system 500 can convert between photodetector response and temperature. However, characteristics of this curve may change with changing ambient temperature. Accordingly, a correction factor can be determined wherein the correction factor can be configured to adjust temperature conversion to account for changes in ambient temperatures. Using the determined curve and correction factor, the thermography system 500 can be configured to convert between photodetector response and temperature, adjusting the conversion based on the ambient temperature (e.g., as provided by a temperature sensor).

During operation, this calibration information can be updated by closing the shutter and acquiring photodetector responses at the temperature of the shutter, the temperature of the shutter being assumed to be equal to the temperature provided by the temperature sensor. Gain factors and/or other adjustments can be determined by closing the shutter, acquiring flat field image data, determining a temperature of the shutter using temperature sensor readings, and adjusting the gain factors so that the photodetector response conversion to temperature results in the known temperature of the shutter. Advantageously, this can improve the accuracy of determined temperatures by updating conversion algorithms using recently acquired data.

The thermography system 500 is configured to receive input signals from a temperature sensor 502 and a photodetector circuit 504. The temperature sensor 502 is configured to provide measurements of temperature. As described herein, the temperature measurements can be correlated to a temperature of an FPA that includes the photodetectors and/or to a shutter of the FPA. The photodetector circuit 504 can be configured to provide an image signal. In some embodiments, the image signal is an adjusted signal that is proportional to a difference between image data acquired with the shutter open and image data acquired with the shutter closed. In certain embodiments, the image signal corresponds to output signals from photodetectors multiplied by a pixel gain factor. Other adjustments may be made to the pixel measurements prior to being provided to the thermography system 500. Examples of filters and other adjustments that can be applied are described herein with reference to FIG. 1A.

The thermography system 500 is configured to determine a temperature corresponding to the signals provided by the temperature sensor 502. The temperature calibration component 506 is configured to receive signals from the temperature sensor 502 and to generate a signal corresponding to a calibrated temperature, the calibrated temperature determined using a conversion function stored in the thermography system 500, such as in a memory device coupled to the thermography system 500. The thermography system 500 can use the output calibrated temperature to adjust calibrated conversion functions to account for photodetector responsivity as a function of ambient temperature.

The thermography system 500 includes an expected signal component 508 configured to receive the signals from the temperature calibration component 506 and to generate signals corresponding to an expected relative signal corresponding to a relative temperature signal received from the temperature calibration component 506. The expected relative signal can be determined using a conversion function stored in the thermography system 500. The expected signal component 508 can be configured to determine an expected flux from a flat field scene, the expected flux being determined based at least in part on the determined calibrated temperature and functions relating observed flux or signal at a photodetector to temperature. The expected flux can be adjusted based at least in part on ambient temperature measurements. In some embodiments, the expected signal component 508 provides a function or curve relating photodetector output to temperature, the function being adjusted for measured ambient temperature provided by the temperature sensor 502. For example, flat field image data acquired with the shutter closed can be used to adjust photodetector temperature conversions to match the temperature of the shutter as provided by the temperature sensor 502. As described herein, these functions can be based on an analysis of blackbody curves at different temperatures.

The thermography system 500 includes a gain compensation component 510 configured to receive signals from the temperature sensor 502 and to produce a compensated gain factor, Km, for use in the thermography system 500. The compensated gain factor can be configured to correct or adjust for changes in responses in the system as a function of changes in ambient temperature. The compensated gain factor, Km, can be determined using a conversion function stored in the thermography system 500. The compensated gain factor, Km, can be scaled by a global gain factor, Gm, corresponding to a ratio of a global gain relative to a nominally determined gain value. The global gain factor, Gm, can be configured to correct or adjust for global gain differences between different devices. The compensated gain factor, Km, and the global gain factor, Gm, can be multiplied together to produce a scaling factor for the image signal from the photodetector circuit 504, producing a scaled image signal.

The thermography system 500 is configured to combine the scaled image signal with the expected relative signal to produce an adjusted expected signal. The adjusted expected signal can be transmitted to a temperature conversion component 512 configured to generate a relative temperature corresponding to the adjusted expected signal. The relative temperature can be determined using a conversion function stored in the thermography system 500, wherein the conversion function is configured to correlate a relative signal to a relative temperature. The thermography system 500 is further configured to apply a temperature adjustment to convert the relative temperature to an absolute temperature measurement (e.g., a temperature expressed in degrees Celsius, Fahrenheit, or in Kelvin). In some embodiments, this includes adjusting the relative temperature by adding a constant to the relative temperature. As described herein, the temperature conversion can be configured to be adjusted based at least in part on ambient temperature. Calibration information can be acquired at known ambient temperatures for a known scene temperature. When the current ambient temperature is different from the ambient temperature at the time of calibration, an adjustment can be made to the temperature conversion to account for this change. Adjustment factors can be applied to during calculation of temperatures based on photodetector output to increase the accuracy of these temperature calculations.

The thermography system 500 can be configured to determine the absolute temperature measurement for individual pixels or for groups of pixels. Thus, the thermography system 500 can be configured to determine temperature within a scene. In some embodiments, the thermography system is configured to determine the temperature at a particular point in a scene with an accuracy of about ±1° C.

### EXAMPLE 1

Example 1 is presented here to illustrate a particular implementation of a thermography system 500 that includes tailored correction and adjustment factors to increase temperature measurements for a variety of ambient temperature conditions. This example is intended as a particularized illustration and should not be read to limit the disclosed thermography systems and methods to the particular equations, factors, or functions discussed in the Example.

As a particular example, the thermography system 500 can convert signals from the temperature sensor 502 into a measured temperature, FPAtemp, using Equation (1):

FPAtemp=(TSroom−TempSen)/TSresolution+Croom (1)

where TSroom is the temperature sensor reading at room temperature, TempSen is the temperature sensor reading in counts, TSresolution is the counts per degree Celsius (e.g., about 17.5 counts/° C.), and Croom is the ambient temperature at the time of a temperature calibration.

The thermography system 500 can be configured to store conversion functions configured to convert between a relative signal and a relative temperature. For example, integrating a blackbody radiation spectrum over a wavelength range (e.g., over the wavelength range from 7.0 to 13.5 microns) for a plurality of temperatures (e.g., using one-degree increments) results in curves that relate a relative signal to temperature. Analyzing this information can result in a function that converts relative temperature, Trel, to relative signal, Srel (Equation (2)), and an inverse function that converts relative signal back to temperature, Equation (3).

Srel=(A₃*Trel³)+(A₂*Trel²)+(A₁*Trel)+A₀ (2)

where A₃=−8.7450×8.7450×10; A₂=0.23448; A₁=31.412; and A₀=1453.4; and

Trel=(B₄*Srel⁴)+(B₃*Srel³)+(B₂*Srel²)+(B₁*Srel)+B₀ (3)

where B₄=−4.3262×10⁻¹⁴; B₃=1.0900×10⁻⁹; B₂−1.0442×10⁻⁵; B₁5.9748×10⁻²; and B₀=−71.958.

Equations (2) and (3) can be determined for an individual FPA based on measurements acquired from reference bolometers or from photodetectors exposed to a flat field scene (e.g., such as when the shutter is closed). The amount of radiation detected while exposed to the shutter or reference shield can be evaluated to determine a midpoint in a spot thermography curve. Using the thermodynamic equations, such as a blackbody emission spectrum, provides for a way to generate a predicted amount of infrared radiation seen by a reference bolometer or a photodetector viewing a closed shutter.

The thermography system 500 can be configured to apply adjustment factors to improve the accuracy of determined temperatures. For example, the thermography system 500 can determine a gain response factor, Km_{gain}, to correct or to adjust for changes in pixel responses with changes in operating temperatures. A function that relates temperature to a gain response factor is in Equation (4):

Km_{gain}=Kmₘᵤₗₜ*exp(Kmₑₓₚ*Tₛₑₙ) (4)

where Kmₑₓₚ=1.5106×10⁻²; Kmₘᵤₗₜ=0.75775.

Similarly, the thermography system 500 can be configured to determine a global response factor, Gm, to correct or adjust for differences between imaging systems or devices. The global response factor, Gm, can be applied as a multiplier to the gain response factor, Km_{gain}. A function that relates properties of devices to the global response factor is in Equation (5):

Gm=GainNominal/GainActual (5)

The thermography system can apply an offset adjustment factor, Ka, to measurements produced by converting adjusted flux or measurement values from pixels to temperature. As an example, the offset adjustment factor, Ka, can be 10.0 when converting signals to temperatures in degrees Celsius. Using these example equations and values, thermography values determined with the thermography system 500 can be within about 1° C. of the actual temperature.

### Example Method for Thermography

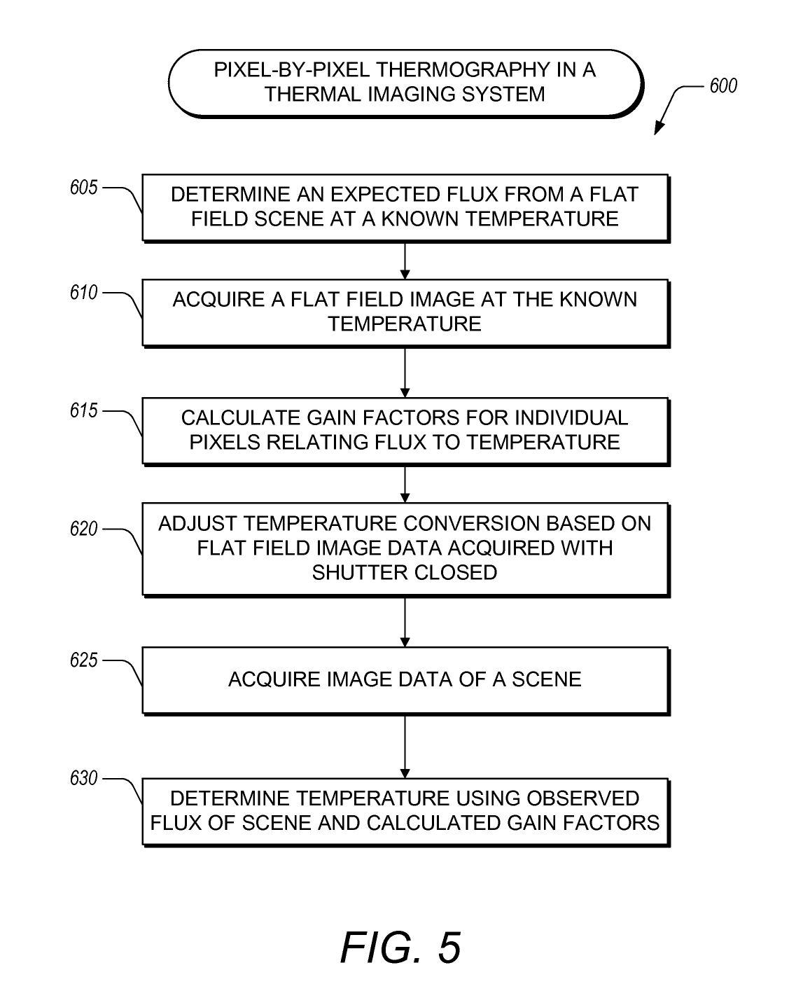

FIG. 5 illustrates a flow chart of an example method 600 for performing thermography in a thermal imaging system. The method 600 can be implemented using one or more hardware components in an imaging system or image processing system. For ease of description, the method 600 will be described as being performed by the imaging system 100 described herein with reference to FIGS. 1A and 1B. However, one or more of the steps of the method 600 can be performed by any module, such as the thermography module 110, or combination of modules in the imaging system 100. Similarly, any individual step can be performed by a combination of modules in the imaging system 100. Likewise, the steps of the method can be performed by the thermography system 500 described herein with reference to FIG. 4.

In block 605, the imaging system determines an expected flux from a flat field scene at a known temperature, the expected flux being determined based at least in part on the determined calibrated temperature and functions relating observed flux or signal at a photodetector to the known temperature. In block 610, the imaging system acquires from the array of photodetectors image data of a flat field scene at a known temperature during a first time period, the image data comprising an array of pixel values. In block 615, the imaging system calculates gain factors for individual pixels, the gain factors relating the observed signal to the expected flux. The imaging system can calculate these gain factors at a plurality of times. In block 620, the imaging system adjusts a temperature conversion based at least in part acquired flat field scene images acquired with the shutter closed. In block 625, the imaging system acquires from the array of photodetectors image data of a scene at a time after the first time period. In block 630, the imaging system uses the actual observed flux at individual pixels with their associated gain factors to relate signals from individual pixels to temperature using the adjusted temperature conversion. The temperature conversion can be derived based on models or measurements of photodetector responsivity and blackbody curves.

The method 600 can be performed on a pixel-by-pixel basis or for groups of pixels. The method can include reading a temperature sensor associated with the thermal imaging system to determine a temperature at the photodetectors. This can be used to estimate the temperature of the flat field scene. This may be useful where the flat field scene is acquired by closing a shutter and imaging the shutter. This may be useful where the flat field scene is acquired from reference bolometers that are occluded using a radiation shield.

In some embodiments, the method 600 may further include calibrating the temperature sensor prior to using the thermal imaging system by exposing the thermal imaging system to a known temperature and observing the temperature sensor value. The difference between the observed value and the known temperature can be used to calibrate temperature readings from the temperature sensor. This can be used to determine expected flat field flux. In certain implementations, multiple known temperature values can be utilized to calibrate the temperature sensor over a range of temperature values.

In some embodiments, the method 600 may further include calibrating the flux observed by each pixel when the FPA is exposed to flat field scenes at a variety of controlled temperatures using a calibration source (e.g., a variable temperature blackbody emitter). The method can also further include developing a flux-dependent gain factor for each pixel and applying this factor when determining scene temperature during camera use.

In some embodiments, the thermal imaging system can be configured to receive selections indicating one or more points in a scene and the thermal imaging system can be configured to determine temperatures at the one or more points and display numerically the determined temperatures on a display such that the displayed numbers are near or adjacent to the one or more points.

### Example Method for Field Calibration for Thermography

In some embodiments, a thermal imaging system can be calibrated for thermography during normal use. The process for performing field calibration can include allowing the thermal imaging system to stabilize in a power-off condition in an environment with a known or stable temperature. The method includes powering on the thermal imaging system and promptly acquiring temperature sensor readings. In certain implementations, the resolution of the temperature sensor can be consistently about 17.5 counts/deg.C from part to part. This resolution can be evaluated intermittently to determine if adjustments are appropriate or desirable. The method includes allowing the part to stabilize for at least 1 minute. The method includes measuring the output while the FPA is exposed to a known low temperature extended source blackbody. The method also includes measuring the output while the FPA is exposed to a known high temperature extended source blackbody. The method also includes using the difference between the high and low blackbody measurements to determine the average responsivity of each unit. The method concludes with applying updated settings and adjusting the offset adjustment factor, Ka, so that the thermography readings increase in accuracy.

A result of the various approaches for performing thermography described herein is that the signal from each pixel can be associated with a temperature of the part of the scene imaged by the pixel. Once the thermography process is accomplished, this temperature data may be presented to the user on a display. One approach is to receive a selection of a spot or region on the display and to determine the temperature(s) for the selected spot or region. For example, the temperature may be displayed numerically adjacent to the spot or next to a crosshair or other icon marking the spot. The displayed temperature, for example, can be based on data per pixel or an average, maximum, minimum, or median of multiple pixels.

The embodiments described herein are exemplary. Modifications, rearrangements, substitute processes, etc. may be made to these embodiments and still be encompassed within the teachings set forth herein. One or more of the steps, processes, or methods described herein may be carried out by one or more processing and/or digital devices, suitably programmed.

Depending on the embodiment, certain acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a processor configured with specific instructions, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. For example, the LUT described herein may be implemented using a discrete memory chip, a portion of memory in a microprocessor, flash, EPROM, or other types of memory.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. A software module can comprise computer-executable instructions which cause a hardware processor to execute the computer-executable instructions.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y or Z,” unless specifically stated otherwise, is otherwise understood with the context as used in general to present that an item, term, etc., may be either X, Y or Z, or any combination thereof (e.g., X, Y and/or Z). Thus, such disjunctive language is not generally intended to, and should not, imply that certain embodiments require at least one of X, at least one of Y or at least one of Z to each be present.

The terms “about” or “approximate” and the like are synonymous and are used to indicate that the value modified by the term has an understood range associated with it, where the range can be ±20%, ±15%, ±10%, ±5%, or ±1%. The term “substantially” is used to indicate that a result (e.g., measurement value) is close to a targeted value, where close can mean, for example, the result is within 80% of the value, within 90% of the value, within 95% of the value, or within 99% of the value.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to illustrative embodiments, it will be understood that various omissions, substitutions, and changes in the form and details of the devices or algorithms illustrated can be made without departing from the spirit of the disclosure. As will be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. A method for performing thermography using individual photodetectors of an imaging system comprising a shutter, an array of photodetectors, and a temperature sensor associated with the imaging system, the method comprising:
calibrating a flux observed by individual photodetectors when exposed to controlled temperature flat field scenes at a plurality of temperatures using a calibration source;
developing at least one gain factor for individual pixels, the gain factor used to convert between pixel output and a temperature value;
acquiring from the array of photodetectors image data of a flat field scene with a shutter closed during operation of the imaging system;
determining a temperature of the shutter based on temperature measurements provided by the temperature sensor;
adjusting the gain factors of the individual pixels so that a conversion of output from an individual pixel to a temperature value results in a temperature value that is substantially similar to the determined temperature of the shutter;
acquiring from the array of photodetectors image data of a scene; and
determining temperature values corresponding to output from individual pixels using the adjusted gain factors.

2. The method of claim 1, wherein the gain factors are used in functions relating flux to temperature, the functions being derived from blackbody curves.

3. The method of claim 1, wherein scene temperatures at one or more photodetectors are displayed numerically on a display adjacent to corresponding pixels on the display.

4. A thermal imaging system comprising:
an imaging array comprising an infrared focal plane array, the infrared focal plane array comprising an array of microbolometers, each pixel of the focal plane array including a microbolometer photodetector;
a temperature sensor configured to provide a signal corresponding to a temperature of the imaging array;
a system controller configured to determine a temperature value for individual pixels, the temperature value corresponding to output of the individual pixels, the system controller configured to:
calibrate a flux observed by individual photodetectors when exposed to controlled temperature flat field scenes at a plurality of temperatures using a calibration source;
develop at least one gain factor for individual pixels, the gain factor used to convert between pixel output and a temperature value;
acquire from the array of photodetectors image data of a flat field scene with a shutter closed during operation of the imaging system;
determine a temperature of the shutter based on temperature measurements provided by the temperature sensor;
adjust the gain factors of the individual pixels so that a conversion of output from an individual pixel to a temperature value results in a temperature value that is substantially similar to the determined temperature of the shutter;
acquire from the array of photodetectors image data of a scene; and
determine temperature values corresponding to output from individual pixels using the adjusted gain factors.

5. The thermal imaging system of claim 4, wherein the gain factors are used in functions relating flux to temperature, the functions being derived from blackbody curves.

6. The thermal imaging system of claim 4, wherein the temperature sensor is mounted on a printed circuit board.

7. The thermal imaging system of claim 4 further comprising a display configured to display the acquired image data.

8. The thermal imaging system of claim 4, wherein the system controller is further configured to numerically display scene temperatures for individual microbolometers, the scene temperatures displayed adjacent to corresponding pixels on the display.
